(19) United States
(12) Patent Application Publication
(10) Pub. No.: US 2021/0039015 A1
(43) Pub. Date: Feb. 11, 2021

(54) FLOW DISTRIBUTION AND COLLECTION FEATURES FOR ENSURING SCALABLE UNIFORM FLOW IN A CHROMATOGRAPHY OR MEMBRANE SEPARATION DEVICE

(71) Applicant: McMaster University, Hamilton (CA)

(72) Inventors: Raja Ghosh, Dundas (CA); Paul Gatt, Ancaster (CA); Umatheny Umatheva, Markham (CA); Guoqiang Che, Hamilton (CA)

(21) Appl. No.: 16/987,845

(22) Filed: Aug. 7, 2020

Related U.S. Application Data
(60) Provisional application No. 62/883,891, filed on Aug. 7, 2019.

(51) Int. Cl. B01D 15/22; B01D 15/14

(52) U.S. Cl. CPC B01D 15/22; B01D 15/14

(57) ABSTRACT

A chromatography device for removing a solute from a fluid is described herein. The device includes a first plate having an inlet, a first primary channel fluidly coupled to the inlet and a first set of secondary channels fluidly coupled to the first primary channel. The device also includes a middle frame housing chromatographic media and a second plate having an outlet, a second primary channel fluidly coupled to the outlet and a first set of secondary channels fluidly coupled to the second primary channel. The first set of secondary channels directs the fluid in a direction that is transverse to a direction of flow of the fluid through the chromatographic media and the second set of secondary channels directs the fluid to the outlet in a direction that is transverse to the direction of flow of the fluid through the chromatographic media.

### RELATED APPLICATIONS

This application claims the benefit of U.S. Provisional Patent Application No. 62/883,891 entitled “FLOW DISTRIBUTION AND COLLECTION FEATURES FOR ENSURING SCALABLE UNIFORM FLOW IN A CHROMATOGRAPHY OR MEMBRANE SEPARATION DEVICE”, the contents of which are hereby incorporated herein in their entirety.

### TECHNICAL FIELD

This disclosure relates generally to chromatography or membrane separation devices and methods, and more specifically, to chromatography or membrane separation devices and methods that provide uniform flow therethrough.

### BACKGROUND

Uniform flow in 3-dimensional (3D) porous media is a pertinent issue that cuts across scientific disciplines. For instance, porous media is widely used for conducting chemical reactions and for separating molecules, the respective efficiencies of these endeavours being critically dependent on the flow uniformity. Chromatography, a separation technique, which is used for a wide range of applications, including high-resolution purification and analysis of molecules, typically utilizes cylindrical devices called columns that house porous packed-beds made up of fine particles. Other types of porous media such as membranes and monoliths could also potentially be used for such separations, but the word chromatography without a qualifier generally implies the use of a particle-packed columns.

Columns are popular as they are easy to fabricate and pack, convenient to use, and have been around for a long time. Their cylindrical shape allows for the packing of the maximum amount of porous media per unit wetted perimeter. The widespread use of columns in chromatography is perhaps also due to the notion that their symmetric structure and the axis-symmetric flow of fluids through them are somehow prerequisites for efficient separation]. However, columns have several limitations that could potentially be addressed by exploring alternative chromatography device formats and designs.

FIG. 1A shows a basic fluidic arrangement in a column where the influent fluid is distributed over the porous media that occupies a much larger cross-sectional area than the inlet, then collected at the other end, and finally directed to the outlet. This is typically achieved by incorporating a flow distributing header at the inlet end and a flow collecting header at the outlet end. The ideal fluidic attribute for chromatography, and for all packed-bed based processes, is that all fluid elements should spend the same amount of time during their transit through the device.

The flow of fluid within a column could be classified at two levels of hierarchy, i.e. radial and axial. This form of fluid flow is usually sustained by keeping the radial pressure drop within the column headers significantly lower than the axial pressure drop across the porous bed. As can be seen in FIG. 1A, the flow path lengths within a column vary, e.g. the paths closer to the periphery are longer than those closer to the axis of the column. Therefore, even if the superficial (or linear) velocity in the axial direction within the column (vₛ) were uniform, the time spent by the different fluid elements i.e. their residence time (τ), would vary depending on the radial location of their respective flow paths. Studies have shown that radial velocity in the header (vᵣ) decreases significantly in the distributing header in a radially outward direction (r) (see FIG. 1B). This is due to the combination of three factors: the area of cross-section for flow within the header increases with r, a part of the liquid flowing in the header is lost due to influx into the packed-bed adjacent to it; and, the area over which liquid influx takes place from the header to the packed-bed increases with r. If the superficial velocity within the column (vₛ) were constant, the rate of change in radial velocity (vᵣ), for r>0, within a distributing header having a fixed height (h), is given by Equation (1), below:

$$\frac{{dv}_{r}}{dr} = - ( \frac{{v}_{r}}{r} + \frac{{v}_{s}}{h} ) \qquad ( 1 )$$

The validity of Equation (1) has been verified based on experimental results and computational fluid dynamic (CFD) simulations. In the collecting header, the radial velocity increases in a radially inward direction, i.e. also following Equation (1). Such significant changes in radial velocity in the two headers, coupled with the variation in flow path lengths implies that the residence time of a fluid element (τ) within the column would indeed depend on the radial location of its flow path (see FIG. 1C). The impact of such location dependent τ on chromatographic separation could be quite significant since 50% of the separation media is located in the outer 29% of the column (see FIG. 1D).

There is a need to address non-uniform flow in columns due to radial variation in τ resulting from the interplay between axial and radial flow, i.e. macro-scale convective dispersion. Non-uniformity in solute transport resulting from micro-scale effects such as eddy, radial and axial dispersion, and pore diffusion, which depend on particle morphology, size and packing heterogeneity has been studied and reported in the literature. However, there are relatively few reports on equipment-related macro-scale convective dispersion. As described above, such dispersion effects could be expected even if vₛ were uniform throughout the column. In columns where vₛ is non-uniform, this effect would simply be further exacerbated.

The impact of macro-scale convective dispersion is considered less significant in an analytical column as its length is significantly greater than its diameter, a factor that greatly reduces the contributions of the radial flows in the two headers. However, in process columns used for large-scale chemical and biological purifications, the bed-height could be comparable to, or even greater than the column diameter. Therefore, non-uniform flow resulting from macro-scale convective dispersion effects could pose a serious challenge.

Chromatographic processes are generally scaled-up by increasing the column diameter and maintaining vₛ constant as scaling-up by increasing the bed-height is impractical. Firstly, increasing the bed-height increases the pressure drop across the column, which in addition increasing pumping cost, results in compression of the chromatographic media, leading to further increase in pressure drop and ultimately decrease the efficiency of separation. However, increasing the column diameter while maintaining the bed-height constant increases the macro-scale convective dispersion effects. When solute molecules are introduced into the column, the solute front gets distorted in the distributing header (t₁ in FIG. 1A). This is further aggravated when the already distorted solute front enters the collecting header (t₂ in FIG. 1A), leading to peak broadening. Peak broadening is highly undesirable as it reduces peak to peak resolution, which impacts both product purity and recovery in a separation process. Peak broadening also results in product dilution and increase in the peak collection time or volume. In bind-and-elute type separation processes, the eluent front undergoes the same fate as the solute front, and this further decreases resolution. Not surprisingly, peak resolution obtained with an analytical column is difficult to achieve using a process column, even when the separation media and bed-height are the same. Other factors such as eddy dispersion, and radial, axial and pore diffusion also contribute towards peak broadening and lowering of resolution. However, these factors are largely independent of device design, and mainly depend on intrinsic properties of the porous media and operating parameters such as the superficial velocity.

The effect of radial flow in the column headers on separation performance has been studied and improved header designs have been proposed. This includes the use of frits, cone shaped distributors, radial distributors, ribbed header, headers with manifolds, and those with fractal features. Alternative column formats such as parallel segmented flow columns and radial flow columns have also been examined. While these approaches have been effective to varying degrees, they all subscribe to the notion that a symmetric column and axis-symmetric flow within it are both critically important.

Accordingly, there is a need for improved chromatography and/or membrane separation devices and methods, and more specifically, to chromatography and/or membrane separation devices and methods that provide uniform flow therethrough

### SUMMARY

In a broad aspect, a chromatography device for removing a solute from a fluid is described herein. The device includes a first plate having an inlet, a first primary channel fluidly coupled to the inlet and a first set of secondary channels, each secondary channel of the first set of secondary channels being fluidly coupled to the first primary channel. The device also includes a middle frame housing chromatographic media, the chromatographic media being configured to remove the solute from the fluid as the fluid passes through the chromatographic media; and a second plate having an outlet, a second primary channel fluidly coupled to the outlet and a first set of secondary channels, each secondary channel of the second set of secondary channels being fluidly coupled to the second primary channel. The first set of secondary channels directs the fluid over a top surface of the chromatographic media in a first direction that is transverse to a direction of flow of the fluid through the chromatographic media; and the second set of secondary channels collects the fluid from a bottom surface of the chromatographic media after the fluid has passed through the chromatographic media and directs the fluid to the outlet in a second direction that is transverse to the direction of flow of the fluid through the chromatographic media.

In at least one embodiment, the first set of secondary channels and the second set of secondary channels each include two or more secondary channels spaced apart from each other.

In at least one embodiment, each secondary channel of the first set of secondary channels is positioned to be opposed from a secondary channel of the second set of secondary channels.

In at least one embodiment, each channel of the first set of secondary channels is configured to have a greater resistance to flow of the fluid than the first primary channel and each channel of the second set of secondary channels is configured to have a greater resistance to flow of the fluid than the second primary channel.

In at least one embodiment, each channel of the first set of secondary channels is configured to have a smaller resistance to flow of the fluid than the chromatographic media and each channel of the second set of secondary channels is configured to have a smaller resistance to flow of the fluid than the chromatographic media.

In at least one embodiment, each of the first primary channel and the second primary channel are configured to have a smaller resistance to flow of the fluid than the chromatographic media.

In at least one embodiment, each secondary channel of the first set of secondary channels has a first same diameter and each secondary channel of the second set of secondary channels has a second same diameter.

In at least one embodiment, the first same diameter and the second same diameter are the same.

In at least one embodiment, the first direction is normal to the direction of flow of the fluid through the chromatographic media.

In at least one embodiment, the first direction is normal to a direction of flow of the fluid through the first primary channel.

In at least one embodiment, the second direction is normal to the direction of flow of the fluid through the chromatographic media.

In at least one embodiment, the second direction is normal to a direction of flow of the fluid through the second primary channel.

In at least one embodiment, the first primary channel carries the fluid in a direction that is parallel to a direction of flow of the fluid through the second primary channel.

In at least one embodiment, the first direction and the second direction are parallel.

In at least one embodiment, the chromatographic media is a packed bed, a membrane sheet or a stack of membrane sheets.

In at least one embodiment, each channel of the first set of secondary channels is equally spaced apart from at least one other channel of the first set of secondary channels along a width of a top surface of the chromatographic media and each channel of the second set of secondary channels is equally spaced apart from at least one other channel of the second set of secondary channels along a width of a bottom surface of the chromatographic media.

In at least one embodiment, the first primary channel is laterally offset from at least a portion of the chromatographic media.

In at least one embodiment, each of the channels of the first set of secondary channels is engraved in the first plate and each of the channels of the second set of secondary channels is engraved in the second plate.

In at least one embodiment, each of the channels of the first set of secondary channels is embedded in the first plate and includes one or more access holes to provide for the fluid to pass from the each of the channels of the first set of secondary channels to the chromatographic media, and each of the channels of the second set of secondary channels is embedded in the second plate and includes one or more access holes to provide for the fluid to pass from chromatographic media to the each of the channels of the second set of secondary channels.

In a broad aspect, a system for removing a solute from a fluid is described herein. The system includes two or more chromatography devices described herein fluidly coupled to each other in parallel.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A shows a flow pattern and solute front in a prior art column separation device.

FIG. 1B shows a radial velocity curve in the column header of the column separation device of FIG. 1A as function of radial location.

FIG. 1C shows a solute residence time distribution graph for the column separation device of FIG. 1A

FIG. 1D shows a sectional view of the column separation device of FIG. 1A showing the location of chromatographic media in the column.

FIG. 2A shows a perspective view of a cuboid packed-bed device according to at least one embodiment including a flow pattern and a solute front of a solute passing through the device.

FIG. 2B shows a flow pattern of spreading and collimation of the solute front in the cuboid packed-bed device of FIG. 2A.

FIG. 3 shows a perspective view of a membrane or monolith based chromatography device according to at least one embodiment including the idealized flow of fluid at three levels of hierarchy, i.e. primary, secondary, and tertiary, therein.

FIG. 4A shows an exploded perspective view of a cuboid chromatography device according to at least one embodiment having two plates and a middle frame.

FIG. 4B shows a perspective view the upper surface of the bottom plate of the device of FIG. 4A showing an arrangement of the secondary and primary channels therein.

FIG. 5A shows a top view of a plate of a cuboid chromatography device according to at least one embodiment, the plate having secondary channels embedded within the body of the plate.

FIG. 5B shows a side view of the plate of FIG. 5A.

FIG. 5C shows a perspective view of the plate of FIG. 5A.

FIG. 6 shows an exploded perspective view of a lateral flow membrane chromatography (LFMC) device according to at least one embodiment having two plates and a middle membrane stack of a membrane sheet or membrane stack or monolith wherein the membrane sheet or membrane stack or monolith could be pre-framed or framed in-situ.

FIG. 7A shows a side view of the top plate of the LFMC device of FIG. 6 showing the primary and secondary channels.

FIG. 7B shows a top-down view and an end view of the top plate of the LFMC device of FIG. 6 showing the primary and secondary channels.

FIG. 7C shows a perspective view of the top plate of the LFMC device of FIG. 6 showing the primary and secondary channels.

FIGS. 8A-8C show a step-by step methodology for assembling the LFMC device of FIG. 6.

FIG. 8D is a photograph including a perspective view of the 15 mL LFMC device of FIG. 6.

FIG. 9A shows simulated velocity profiles in the top and bottom secondary channels of a 200 mL cuboid chromatography device packed with Capto Q, at a flow rate of 10 mL/min.

FIG. 9B shows a simulated pressure profile in a 200 mL cuboid chromatography device packed with Capto Q, at a flow rate of 10 mL/min.

FIG. 10A shows CFD simulation data of a 2000 kDa dextran solute front in a 200 mL cuboid chromatography device.

FIG. 10B shows two images of a 2000 kDa blue dextran solute front in 200 mL cuboid chromatography device.

FIG. 11 shows a graph of dextran tracer peaks obtained by CFD simulation for 200 mL column, cuboid and cuboid z² devices packed with Capto Q strong anion exchange chromatographic media (tracer: 2000 kDa dextran; concentration: 10 g/L, pulse volume: 1 mL, flow rate: 10 mL/min).

FIG. 12 shows a graph of experimentally obtained blue dextran tracer peaks for the 200 mL column and the cuboid z² device packed with Capto Q strong anion exchange chromatographic media (tracer: 2000 kDa blue dextran; concentration: 10 g/L, pulse volume: 1 mL, flow rate: 10 mL/min).

FIG. 13A shows a schematic representation of fluid flow in a cuboid chromatography device according to at least one embodiment.

FIG. 13B shows a schematic view of a multiplexing of cuboid chromatography devices by fractal scaling.

FIG. 14 shows a graph of model protein separation using a 5 mL HiTrap QFF column at different flow rates (binding buffer: 20 mM Tris buffer, pH 8.0; eluting buffer: binding buffer+0.5 M sodium chloride; gradient: 15 mL; protein sample: 1.5 mg/mL BSA and 0.5 mg/mL transferrin prepared in binding buffer; loop: 0.1 mL).

FIG. 15 shows a plot of the effect of flow rate on the resolution of BSA-transferrin separation using 5 mL Q Sepharose Fast Flow column and 5 mL Q z²LFMC device.

FIG. 16 shows a graph of model protein separation using a 5 mL Q z²LFMC device at different flow rates (binding buffer: 20 mM Tris buffer, pH 8.0; eluting buffer: binding buffer+0.5 M sodium chloride; gradient: 15 mL; protein sample: 1.5 mg/mL BSA and 0.5 mg/mL transferrin prepared in binding buffer; loop: 0.1 mL).

FIG. 17A shows a graph of model protein separation using a 15 mL Capto S ImpAct column at a flow rate of 2 mL/min using 300 mL linear gradient.

FIG. 17B shows a graph of model protein separation using a 15 mL Capto S ImpAct column at a flow rate of 10 mL/min using 300 mL linear gradient (binding buffer: 20 mM sodium acetate buffer, pH 5.0; eluting buffer: binding buffer+0.5 M sodium chloride; protein sample: 1.5 mg/mL conalbumin, 1.0 mg/mL ribonuclease A, 0.5 mg/mL cytochrome C and 0.5 mg/mL lysozyme prepared in binding buffer; loop: 0.5 mL).

FIG. 18 shows a graph of model protein separation using a 15 mL S z²LFMC device at a flow rate of 15 mL/min using 300 mL linear gradient (binding buffer: 20 mM sodium acetate buffer, pH 5.0; eluting buffer: binding buffer+0.5 M sodium chloride; protein sample: 1.5 mg/mL conalbumin, 1.0 mg/mL ribonuclease A, 0.5 mg/mL cytochrome C and 0.5 mg/mL lysozyme prepared in binding buffer; loop: 0.5 mL).

FIG. 19 shows a graph of monoclonal antibody (hIgG1-CD4) charge variant fractionation using a 15 mL S z²LFMC device at a flow rate of 20 mL/min using 500 mL linear gradient (membrane: Sartobind S strong cation exchange; binding buffer: 20 mM sodium acetate buffer, pH 5.0; eluting buffer: binding buffer+0.5 M sodium chloride; mAb sample: 0.479 mg/mL hIgG1-CD4 in binding buffer; loop: 1 mL).

FIG. 20 shows a graph of separation of aggregates from a 5 mL of monoclonal antibody (Campath-1H) sample using a 15 mL S z²LFMC device at a flow rate of 20 mL/min using 200 mL linear gradient (membrane: Sartobind S strong cation exchange; binding buffer: 20 mM sodium acetate buffer, pH 5.0; eluting buffer: binding buffer+0.5 M sodium chloride; mAb sample: 0.3 mg/mL Campath-1H in binding buffer).

FIG. 21A shows a CFD simulation of velocity profile in the two primary channels and the top set of secondary channels of a 1 mL z²LFMC module according to at least one embodiment at a flow rate of 5 mL/min.

FIG. 21B shows a CFD simulation of pressure profile in the membrane stack and the top and bottom secondary channels of a 1 mL z²LFMC module according to at least one embodiment at a flow rate of 5 mL/min.

FIG. 22 shows a CFD simulation of sodium chloride flow through peaks for a 1 mL LFMC module with tapered flow distribution and a 1 mL z²LFMC module according to at least one embodiment (mobile phase: water; tracer: 2 M sodium chloride; pulse volume: 25 μL; membrane bed-volume: 1 mL; flow rate: 5 mL/min).

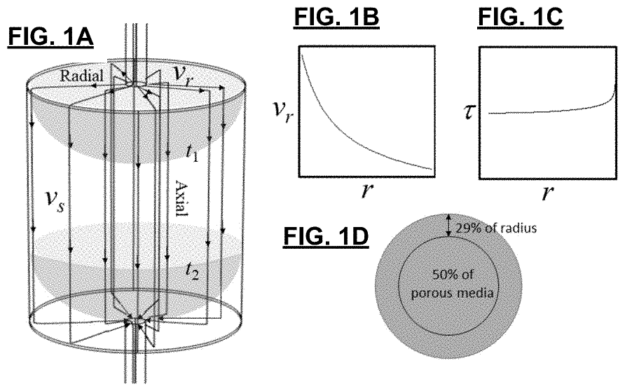

Further aspects and features of the example embodiments described herein will appear from the following description taken together with the accompanying drawings.

### DETAILED DESCRIPTION

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive—or. That is, “X and/or Y” is intended to mean X, Y or X and Y, for example. As a further example, “X, Y, and/or Z” is intended to mean X or Y or Z or any combination thereof. Also, the expression of A, B and C means various combinations including A; B; C; A and B; A and C; B and C; or A, B and C.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Recently, there has been a growing interest in developing new systems, devices and methods for chromatographic and/or membrane separation.

Notwithstanding the foregoing, the inventors believe that the flow arrangements described herein may have applications outside of traditional solute separation by chromatography. For instance, the inventors believe that the flow arrangements described herein may be incorporated in fixed-bed (or packed-bed) chemical and biochemical reactors, an example being automobile catalytic converters. Similarly, the flow arrangement could be incorporated in other devices and processes involving flow in porous media, such as fixed-bed (or packed-bed) extractors and water filters.

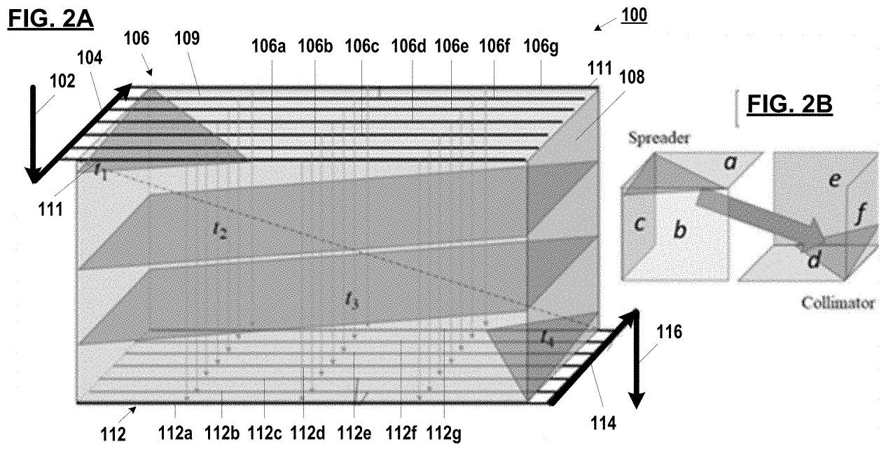

Turning to the figures, chromatography and/or membrane separation devices and methods are described herein. In at least one embodiment, a chromatography device 100 is shown in FIG. 2A. Device 100 includes an inlet 102 configured to receive an influent fluid (e.g. liquid) and direct the influent fluid into a first primary channel 104. First primary channel 104 is transverse to the inlet 102. In the embodiment shown, first primary channel 104 is perpendicular to the inlet 102. First primary channel 104 may also be laterally offset from separation (i.e. chromatographic) media (e.g. packed-bed or one or more membranes) 108. Herein, the terms “separation media” and “chromatographic media” are used interchangeably and include but are not limited to packed beds and one or more (e.g. a stack) of membranes for separating a solute from a fluid (e.g. a liquid or a gas). Prior to passing through the separation media 108, the fluid passes through a first set of secondary channels 106. The first set of secondary channels 106 includes at least two secondary channels 106a, 106b. In the embodiment shown in FIG. 2A, the first set of secondary channels 106 includes 7 secondary channels, 106a, 106b, 106c, 106d, 106e, 106f, 106g, respectively. In at least one embodiment, the first primary channel 104 is offset from a portion of the separation media 108 (e.g. from an edge of the separation media) by a distance in the order of millimeters (mm). In at least one embodiment, the first primary channel 104 is offset from a portion of the separation media 108 (e.g. from an edge of the separation media) by a distance in the order of centimeters (cm). Generally, the distance that the first primary channel 104 is offset from the portion of the separation media 108 is dependent on the size of the device 100.

Each of the secondary channels, for example secondary channels 106a-106g of FIG. 2A, of the first set of secondary channels 106 sequentially branches off from the first primary channel 104 and is generally aligned and parallel to each other secondary channel of the first set of secondary channels 106. In at least one embodiment, each of the secondary channels of the first set of secondary channels 106 is exposed on one side to the separation media 108 (e.g. below) to provide for the fluid to pass from each of the secondary channels to the separation media 108. Exposure may be by one or more apertures in each of the secondary channels of the first set of secondary channels 106. In this manner, the secondary channels of the first set of secondary channels 106 collectively receives the fluid from the primary channel 104 and delivers the fluid to the separation media 108. The secondary channels of the first set of secondary channels 106 extend in a direction that is transverse to the primary channel 104 and is also transverse to the direction of flow of the fluid through the separation media 108.

The first set of secondary channels 106 may be evenly dispersed across a top surface 109 of the separation media 108. For instance, each of the secondary channels of the first set of secondary channels 106 may be evenly spaced apart from at least one other secondary channel of the first set of secondary channels 106 across the top surface 109 of the separation media 108. Further, as shown in FIG. 2A, one or more secondary channels of the first set of secondary channels 106 may be positioned at or above a respective edge of the top surface 109 of the separation media 106. For instance, as shown in FIG. 2A, secondary channel 106a and secondary channel 106g are each respectively positioned at or above an edge 111 of the top surface 109 of the separation media 108. After entering the separation media 108, the influent fluid flows through the separation media 108 in a direction that is normal to each of the secondary channels of the first set of secondary channels 106.

The dimensions of each of the first primary channel 104 and the second primary channel 114 (e.g. the diameter) may vary and will typically depend on the size and capacity of the device 100. For instance, in one example, for small-scale lab devices, the first primary channel 104 and/or the second primary channel 114 will have a diameter of the order of millimeters. In another example, for larger scale flow devices, the first primary channel 104 and/or the second primary channel 114 will have a diameter of the order of centimeters.

The dimensions of each of the channels of the first set of secondary channels 106 and the second set of secondary channels 112 (e.g. the diameter) may vary and will typically depend on the size and capacity of the device 100. For instance, in one example, for small-scale lab devices, each of the channels of the first set of secondary channels 106 and the second set of secondary channels 112 will have a diameter of the order of millimeters. In another example, for larger scale flow devices, each of the channels of the first set of secondary channels 106 and the second set of secondary channels 112 will have a diameter of the order of centimeters. It should be understood that each of the channels of the first set of secondary channels 106 and the second set of secondary channels 112 has a diameter that is smaller than the diameters of the first primary channel 104 and the second primary channel 114.

The fluid is collected after exiting the separation media 108 by a second set of secondary channels 112. Second set of secondary channels 112 are positioned opposed to the first set of secondary channels 106. For example, in the embodiment shown in FIG. 2A each channel 112a-112g is positioned below the separation media 108 in a position opposed to a respective secondary channel of the first set of secondary channels 106. As shown, secondary channel 112a of the second set of secondary channels 112 is positioned directly below secondary channel 106a of the first set of secondary channels 106, secondary channel 112b of the second set of secondary channels 112 is positioned directly below secondary channel 106b of the first set of secondary channels 106, secondary channel 112c of the second set of secondary channels 112 is positioned directly below secondary channel 106c of the first set of secondary channels 106, secondary channel 112d of the second set of secondary channels 112 is positioned directly below secondary channel 106d of the first set of secondary channels 106, secondary channel 112e of the second set of secondary channels 112 is positioned directly below secondary channel 106e of the first set of secondary channels 106, secondary channel 112f of the second set of secondary channels 112 is positioned directly below secondary channel 106f of the first set of secondary channels 106, and secondary channel 112g of the second set of secondary channels 112 is positioned directly below secondary channel 106g of the first set of secondary channels 106.

Each of the secondary channels of the second set of secondary channels 112 is also exposed on one side to the separation media 108 to receive the fluid from the separation media 108. Again, exposure may be by way of one or more apertures in each of the secondary channels of the second set of secondary channels 112.

The fluid received into each of the secondary channels of the second set of secondary channels 112 is the collected by the secondary channels and provided to a second primary channel 114 that extends transverse (e.g. perpendicular) to each of the secondary channels of the second set of secondary channels 112. The second primary channel 114 may also be offset from the separation media108. Second primary channel 114 collects the fluid from the secondary channels of the second set of secondary channels 112 and provides the fluid to an outlet 116. Outlet 116 extends in a direction that is transverse (e.g. perpendicular) to the second primary channel 114. In at least one embodiment, outlet 116 may extend in a direction that is parallel to the direction of flow of the fluid as the fluid passes through the separation media 108.

In at least one embodiment, the arrangement of the first primary channel 104, the first set of secondary channels 106, the second set of secondary channels 112 and the second primary channel 114 with respect to each other, for example as shown in the device 100 of FIG. 2A, provides for the flow path lengths of the fluid through the device 100 to be consistent.

In at least one embodiment, the arrangement of each of the first primary channel 104, the first set of secondary channels 106, the second set of secondary channels 112 and the second primary channel 114 as straight flow channels may minimize back mixing in the device 100.

In at least one embodiment, a hierarchical arrangement of the flow paths at three levels, i.e., in the primary channels 104, 114, in each of the secondary channels of the first and second sets of secondary channels 106, 112, respectively, and within the separation media 108, provide for uniform flow within the device. The resistance to flow of the fluid through the primary channels 104, 114 is less than the resistance to the flow of the fluid through the first and second sets of secondary channels 106, 112, respectively. The resistance to the flow of the fluid through the primary channels 104, 114 is less than the resistance to the flow of the separation media 108. The resistance to the flow of the fluid through the first and second sets of secondary channels 106, 112, respectively, is less than the resistance to the flow of the fluid through the separation media 108. The above noted relative resistances are maintained through operation of the device 100 to provide for the flow patterns illustrated in FIGS. 2, for example.

In at least one embodiment, each hypothetical flow path within the devices described herein has equal primary, secondary and tertiary flow path-length components. For instance, the first primary channel 104 and the second primary channel 114 are symmetrical, the first set of secondary channels 106 and the second set of secondary channels 112 are symmetrical and the path lengths through the separation media 108 are equivalent. In at least one embodiment, the hydraulic resistances along each of these flow paths is the same. These factors may provide for the device 100 to have a narrow solute residence time distribution (e.g. a narrower solute residence time distribution than a control device without the arrangement of channels described herein (e.g. hierarchal arrangement of channels/flow paths)).

Overall, in at least one embodiment, the influent fluid is introduced into the device 100 and the effluent fluid is collected from the device 100 along its space diagonal. FIG. 2A shows an idealized solute front within the device 100 at different times (i.e. t₁, t₂, t₃, and t₄). Due to the manner in which fluid is distributed and collected in device 100, the solute front slants backwards and to the right (with reference to the general direction of flow shown in FIG. 2A). As can be seen in FIG. 2B, this combination of slants results in better collimation of the solute front at the device outlet 116 in comparison to a prior art packed-bed device with a tapered inlet and outlet. Faces a, b and c (see FIG. 2B) serve as a spreader, while faces d, e and f serve as a collimator. Device 100 is generally considered to be more compact (e.g. have smaller volume than prior art devices) due to the absence of tapers, for example, at the inlet and the outlet of the device.

The overall flow of fluid within device 100 may be visualized as a combination of two z-patterns, i.e. one along the x-y plane and one along the x-z plane (see FIG. 2A). To the best of the inventors' knowledge, the use of a combination of fluid flow in two z-patterns in three-dimensional porous media for chromatographic separation has not been reported in the literature. Moreover, second z-pattern flow within the device 100 (i.e. along the x-z) plane is merely visualized and does not involve real physical z-manifolds in that direction.

In at least one embodiment, another difference between the devices described herein and prior art devices may be that, while with the previous design, the flow of fluid was arranged in two levels of hierarchy, i.e. along the lateral channels and along the porous bed, with the new design, the fluid flow was arranged in three different levels of hierarchy, i.e. primary level flow in the primary channels, secondary level flow in the secondary channels, and tertiary level flow in the porous bed. To provide this three level hierarchy of flow, in at least one embodiment, the resistance to flow in the separation media 108 may be greater than that in the first set of secondary channels 106 and the second set of secondary channels 112, which in turn should be greater than that in the first primary channel 104 and the second primary channel 114.

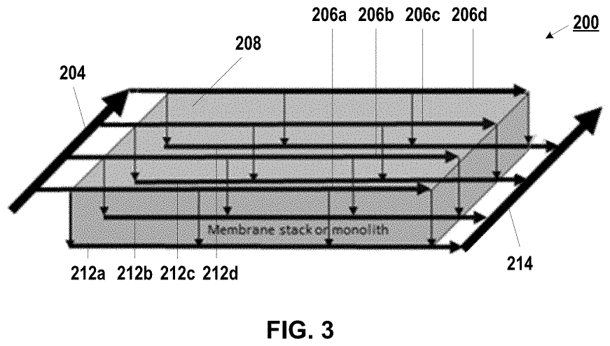

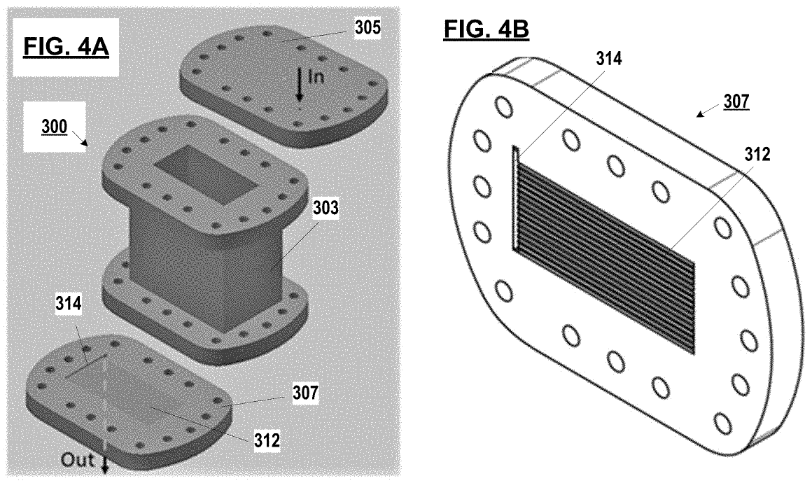

Turning to FIG. 3, shown therein is another embodiment of a chromatography device. In this embodiment, the device 200 includes a membrane stack 208 (or a monolith 208) as a separation media. This embodiment also includes four secondary channels 206a-206d within the first set of secondary channels 206 and, correspondingly, four secondary channels 212a-212d within the second set of secondary channels 212. First primary channel 104 is shown as being laterally spaced from membrane stack 208 and second primary channel 214 is shown as being laterally spaced from the membrane stack 208.

### EXAMPLES

### Experimental Setup

The workings of the chromatography devices described herein may be further explained based on CFD simulations. Experiments were carried out using a 200 mL packed-bed device, a separate cuboid packed-bed chromatography device based on a previous design, and a commercially sourced equivalent column. For the sake of simplicity, these three devices will be referred to as the cuboid z² device, the cuboid device and the column below, respectively.

Two different chromatographic media, i.e. Capto Q anion exchange and Capto S cation exchange, were tested in the following experiments. Efficiency attributes such as the number of theoretical plates and the reduced plate height were compared. The cuboid z² device performed better than the cuboid device, and both of these devices significantly outperformed the column device. Flow-through experiments were performed using 2000 kDa MW blue dextran as an unbound macromolecular tracer to compare the fluidics of the cuboid z² device with the column. These experimental results were compared with those obtained by CFD simulations.

In addition, experiments were also carried out using a 5 mL and a 15 mL z² lateral flow membrane chromatography (LFMC) devices. Two different types of membranes were used in these experiments. The 5 mL device housed a stack of strong anion exchange (Q) membranes with 0.8-micron pore size, while the 15 mL device housed a stack of strong cation exchange (S) membranes having pore size in the 3-5 microns range. The protein separation performance of the 5 mL Q z² LFMC module was compared with a 5 mL QFF resin based column while that of the 15 mL S z² LFMC module was compared with a 15 mL Capto S ImpAct resin-packed column. The 15 mL S z² LFMC module was then used for two biopharmaceutical purification case studies, including the fractionation of monoclonal antibody charge variants and separation of monoclonal antibody aggregates. Finally, CFD simulations for a 1 mL z² LFMC and an equivalent regular LFMC module with tapered inlet and outlet (based on an older design) were also carried out.

### I. 200 mL Packed Bed Device

Blue dextran (2000 kDa MW, catalogue number D4772) was purchased from Millipore-Sigma (Burlington, Mass., USA). Sodium chloride (SOD002.205) was purchased from Bioshop (Burlington, ON, Canada). Strong cation exchange resin (Capto S, product number 17-5441-01), strong anion exchange resin (Capto Q, product number 17-5316-02), and GE XK50/20 column (ID: 50 mm, product number 28-9889-52) were purchased from GE Healthcare Biosciences, QC, Canada. All buffers and solutions were prepared using ultra-pure water (18.2 MΩ-cm) obtained from a Diamond NANOpure water purification unit (Barnstead International, Dubuque, Iowa, USA), and micro-filtered and degassed under vacuum using a membrane filtration device fitted with 0.2 μm pore-size cellulose nitrate membrane discs.

The 200 mL bed-volume cuboid and cuboid z² devices used in this study were designed and fabricated in-house. These were made of acrylic-based materials. The basic design of the prior art cuboid device included three pieces: a rectangular middle frame with a rectangular slot (62.7 mm length×31.3 mm width×100 mm height) for housing the ˜200 mL packed-bed, with plates on both sides, each engraved with a tapered and pillared lateral channel. The design of the cuboid z² device is shown in FIG. 4A. FIG. 4A shows the three pieces comprising the device 300. In this embodiment, a rectangular central frame 303 was used and two plates, a top plate 305 and a bottom plate 307, were positioned on opposed sides of the central frame 303. Each of top plate 305 and bottom plate 307 were engraved with a primary channel (the first primary channel not shown and the second primary channel being shown as channel 314). Further, in this embodiment, each of the top plate 305 and bottom plate 307 were engraved with a set of secondary channels. For instance, bottom plate 307 includes the second set of secondary channels 312. In at least one embodiment, the second set of secondary channels described herein are open channels. In at least one embodiment, the second set of secondary channels described herein may include one or more flow regulation features such as but not limited to inserts and/or appropriately sized beads and/or other solid objects. In at least one embodiment, the secondary channels are open on a side facing the separation media (e.g. membrane/porous bed). FIG. 4B shows a perspective view of the bottom plate 307 of the device 300 showing the second primary channel 314 and the second set of secondary channels 312. It should be understood that the channel layout of the top plate 305 was complimentary with respect to the bottom plate 307.

In this embodiment, each of the primary channels had semi-circular cross-section of 0.992 mm radius, the flat side of the cross-section facing outward. The secondary channels also had semi-circular cross-section, the radius of each being 0.596 mm. As with the primary channels, the flat side of the cross-section faced outward. The inlet (not shown) connected to the first primary channel (not shown) while the outlet (not shown) connected to the second primary channel 314 in the bottom plate 307.

In both cuboid devices used in this study, the respective packed-beds were separated from the lateral channels or the secondary channels using a nylon mesh (0.002 inch opening, product number 9318T48, McMaster Carr, USA). The mesh retained the resin within the device. The GE XK50/20 column which was used as the equivalent column for comparison had an inner diameter of 50 mm and was packed to 100 mm bed height. Therefore, the effective bed volume of all three devices which had identical bed height (i.e. 100 mm) was about 200 mL (196.3 mL for the two cuboid devices and 196.4 mL for the column). During the chromatography experiments, the cuboid device or the column being used was integrated with an AKTA prime liquid chromatography system (GE Healthcare Biosciences, QC, Canada) using peak tubing, and samples were injected using appropriate sample loops.

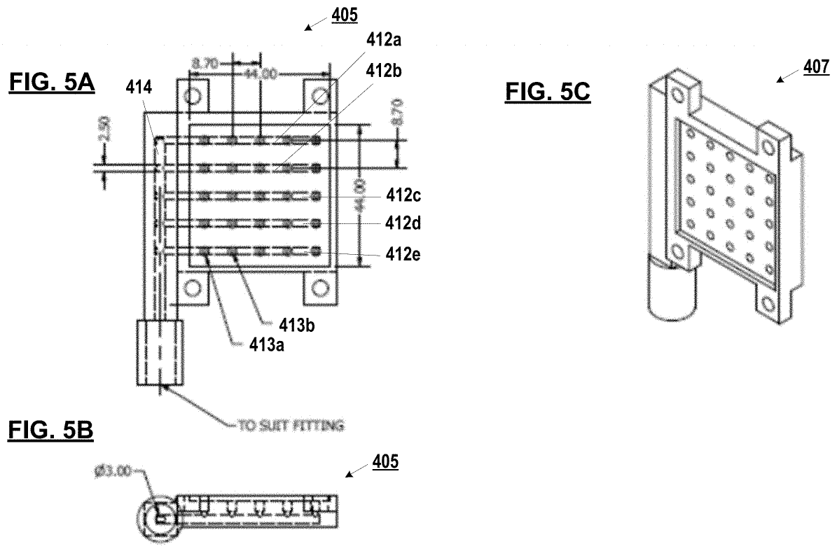

FIG. 5 shows an alternative form of the plate for a z²cuboid device. In the plates shown in FIG. 4, the secondary channels (e.g. the second set of secondary channels 312) were engraved as open channels. In this embodiment, the secondary channels are embedded within the body of the plate. On the top of the cuboid device, the fluid from these secondary channels are fed into the separation media (e.g. packed-bed) through a series of access holes 413 (as shown in FIG. 4A). In a similar way, the fluid from the packed-bed is collected in the secondary channels located at the bottom of the device by a corresponding set of access holes 413. In this embodiment, the secondary channels each has a diameter of about 2.50 mm, each of the secondary channels is separated by 8.70 mm, and each of the access holes is separated by 8.70 mm.

CFD simulations were carried out with COMSOL Multiphysics 5.4 (COMSOL, Inc., Burlington, Mass., USA) using Brinkman Equations and Transport of Diluted Species in Porous Media physics packages. All device geometries were meshed using tetrahedral meshing elements and solved with a relative tolerance of 10-3. Chromatography media and solute properties used in the simulation are listed in Table 1. In the simulations, the tracer solute was introduced as a pulse, represented by rectangular function, at the inlet of each device at t=0 s.

TABLE 1
Chromatographic media and solute properties
used in the CFD simulations.

| Parameter | Value |
|---|---|
| Flow rate (m³/s) | 1.67 × 10⁻⁷ |
| Capto Q/S Porosity (−) | 0.37 |
| Capto Q/S Permeability (m²) | 1.296 × 10⁻¹² |
| Diffusion coefficient of 2000 kDa Dextran | 2.3 × 10⁻¹¹ |
| in water (m²/s) | |
| Concertation of 2000 kDa dextran in tracer | 5 × 10⁻⁶ |
| pulse (kg − mol/m³) | |
| Pulse injection volume (m³) | 1 × 10⁻⁶ |

### II. 1-15 mL Membrane Device

In another example, Mustang Q strong anion-exchange membrane sheets (MSTGQ3R) were purchased from Pall Canada Ltd. (Mississauga, ON, Canada). Sartobind S strong cation-exchange membrane sheets (94IEXS42-001) were purchased from Sartorius-Stedium Biotech (Gottingen, Germany). HiTrap QFF column (5 mL, 17-5156-01) and Capto S ImpAct (17-3717-01) resin was purchased from GE healthcare Life Sciences (Piscataway, N.J., USA). Millipore Vantage® L Laboratory Column VL 16×250 was kindly donated by PlantForm Corporation, Guelph, ON, Canada. BSA (A2153), bovine transferrin (82058), conalbumin (C7786), ribonuclease A (R6513), cytochrome C (C7752), lysozyme (L6876), and other chemicals used to make buffers were purchased from Sigma-Aldrich (St. Louis, Mo., USA). Humanized monoclonal antibodies Campath-1H and hIgG1-CD4 were kindly donated by the Therapeutic Antibody Center, University of Oxford, Oxfordshire, UK. Sodium chloride (SOD002.205) was purchased from Bioshop (Burlington, ON, Canada). All buffers and solutions were prepared using deionized water obtained from a SIMPLICITY 185 water purification unit Millipore (Molsheim, France). Freeman 1085 Polyurethane Elastomer (Batch #77032) consisting to the resin (part A) and hardener (part B) was purchased from Freeman Manufacturing and Supply Company, Avon, Ohio, USA.

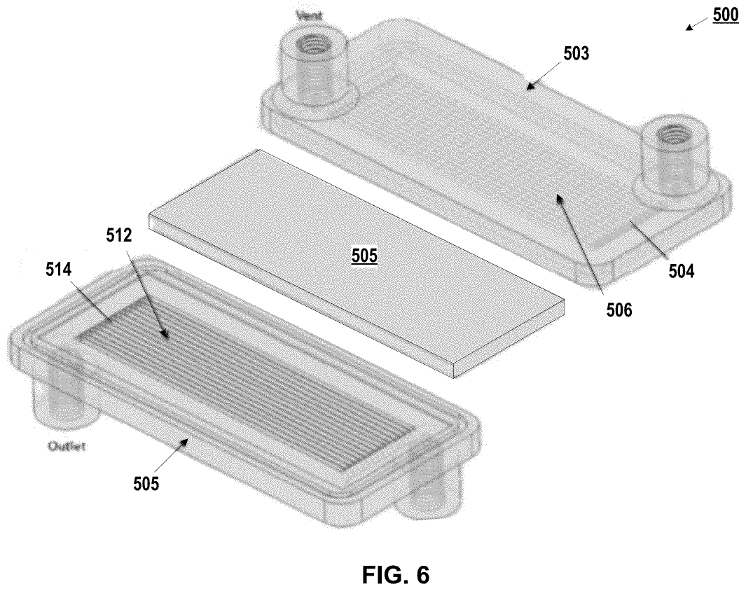

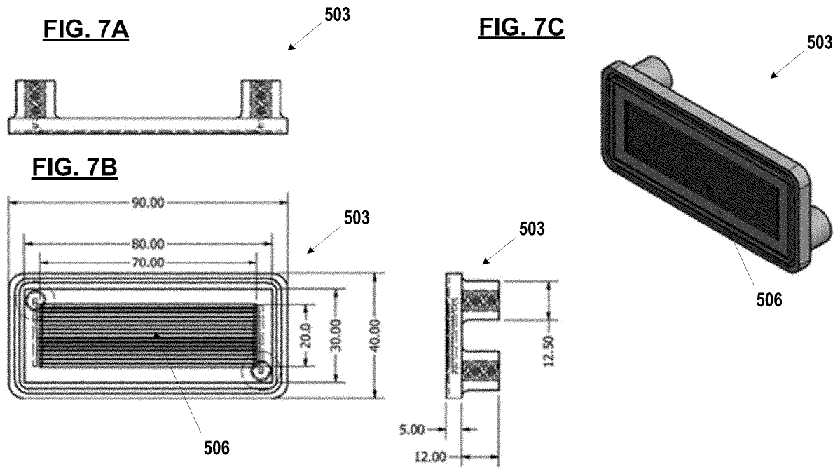

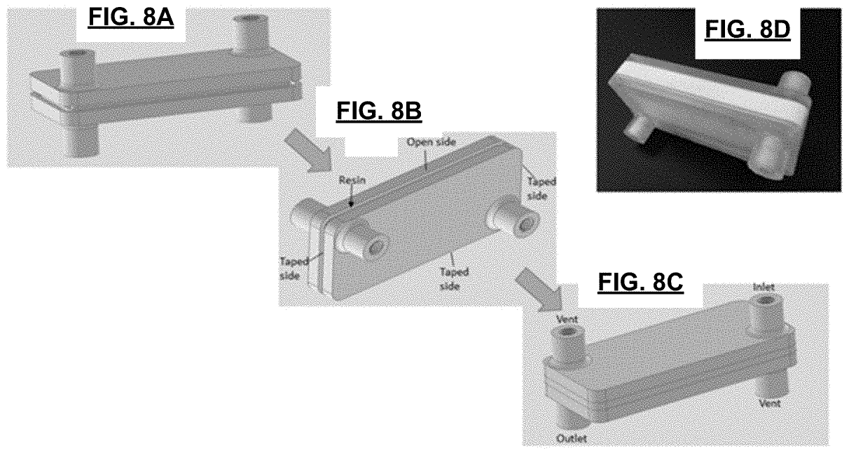

The main components of the device 500 shown in FIG. 6 include a first (e.g. top) plate 503, a membrane stack 508 and a second (e.g. bottom) plate 505. The plates were fabricated using a Form 2 3-D printer (Formlabs, Somerville, Mass., USA) with Form labs Standard resin. The top 503 and bottom 505 plates were provided with primary channels 504 and 514, respectively (circular cross-section of 0.75 mm diameter), which were in turn connected to a set of open semi-circular secondary channels 506 and 512 (each of 0.75 mm diameter), respectively. A detailed drawing of the top plate is shown in FIG. 7. Each plate was also provided with a vent channel, similar in design to the primary channel. The vents, which were used to prime the z² LFMC device and to remove entrapped air bubbles, were kept closed during the chromatography experiments. Similar sets of plates were used for making the two devices used in this study. The membrane stacks were prepared using rectangular pieces of membranes (each 20 mm×70 mm). The membrane bed height of the 5 mL bed volume device was 3.6 mm (made from 26 Mustang Q membrane sheets), and that in the 15 mL device was 10.7 mm (made from 39 Sartobind S membranes sheets). As shown in FIG. 6, the layout of primary and secondary channels in the top and bottom plates of the device 500 was complimentary in order to obtain a z² flow pattern. The steps involved in assembling a z² LFMC device are summarized in FIGS. 8A-8C. Briefly, the corresponding membrane stack was sandwiched between the two plates (see FIG. 8A) and held together using a clamp. Three sides of this sandwiched assembly were closed using masking tape, leaving one side open (see FIG. 8B). The space between the plates around the membrane stack was filled with the Freeman Polyurethane Elastomer mixture prepared by mixing the resin (part A) with the hardener (part B) in a 1:1 ratio. The mixture was allowed to stand for 24 hours, which on quenching and hardening, held the top and bottom plates together, and sealed the membrane stack in place between them (see FIG. 8C). FIG. 8D shows a photograph of the 15 mL z²LFMC device prepared using the above method.

CFD simulations for a 1 mL z²LFMC device and an equivalent regular LFMC module with tapered inlet and outlet (based on an older design) were also carried out. The length of the membrane stack was 38 mm, its width was 10 mm, and the membrane bed height in these 1 mL modules was 2.75 mm. The channel height of the regular LFMC module was 0.5 mm and the taper angle was 27 degrees. The radius of the primary channel in the LFMC module with z² flow feature was 1.298 mm, while the radius of a secondary channel 0.596 mm. The geometries of the two devices were meshed using tetrahedral meshing elements, and solved with a relative tolerance of 10⁻³. Key properties of the membrane and the tracer solute (sodium chloride) used are listed in Table 2. While carrying out the simulations, the tracer solute was introduced in the form of a pulse (represented by rectangular function) at the inlet of each device at time=0 s.

TABLE 2
Membrane and tracer solute properties used for CFD simulation of
1 mL membrane chromatography devices.

| Parameter | Value |
|---|---|
| Inlet flow rate (m³/s) | 8.33 × 10⁻⁸ |
| Membrane Porosity (−) | 0.78 |
| Membrane permeability (m²) | 1.18 × 10⁻¹⁴ |
| Diffusion coefficient of NaCl in water (m²/s) | 2.9 × 10⁻⁹ |
| Concentration of NaCl in injected tracer (M) | 2 |
| Pulse injection volume (μL) | 25 |

### Results

### I. 200 mL Packed Bed Device

The efficiency of the cuboid z² device was compared with its equivalent column and cuboid device at two different flow rates, i.e. 10 and 20 mL/min. Table 3 summarizes the number of theoretical plates per unit bed height (\dot{N}) and reduced plate height (h) data obtained with these devices packed with Capto S strong cation exchange media. The number of theoretical plates (N) in these devices was determined using Equation (2), below, based on salt tracer peaks obtained by injecting 2 mL (1% of bed volume) of 0.8 M sodium chloride solution as tracer. The mobile phase used in these experiments was 0.4 M sodium chloride solution.

N=5.545 (V_{R}/w_{0.5})² (2)

where V_{R} is the peak retention volume and w_{0.5} is the peak width at half height. The reduced plate height was obtained by dividing the height of a theoretical plate (i.e. \dot{N}⁻¹) with the diameter of the chromatographic media (i.e. 90 μm). At both flow rates, the cuboid z² device performed better than the cuboid device in terms of both metrics, clearly showing the positive impact of the new flow distribution and collection feature. Also, both cuboid devices substantially outperformed the column. Having established that the z² flow distribution/collection feature did indeed improve the separation efficiency of the cuboid device, all subsequent performance comparison experiments were carried out using the cuboid z² device and the column. Table 4 summarizes separation efficiency data obtained using these devices packed with Capto Q strong anion exchange media. Consistent with data shown in Table 3, the cuboid z² device substantially outperformed the column in terms of both separation metrics.

TABLE 3
Number of theoretical plates per meter and reduced plate height data
obtained with 200 mL column, cuboid and cuboid z² devices packed
with Capto S strong cation exchange chromatographic media.

| | Flow rate | | |
|---|---|---|---|
| | (mL/min) | \dot{N} (m⁻¹) | H |
| Column | 10 | 7269 | 1.53 |
| | 20 | 5417 | 2.05 |
| Cuboid | 10 | 8908 | 1.25 |
| | 20 | 6627 | 1.68 |
| Cuboid z² | 10 | 9111 | 1.22 |
| | 20 | 6726 | 1.65 |

Error range: <±5% for experiments run in triplicate.

TABLE 4
Number of theoretical plates per meter and reduced plate height data
obtained with 200 mL column and cuboid z² device packed
with Capto Q strong cation exchange chromatographic media.

| | Flow rate | | |
|---|---|---|---|
| | (mL/min) | \dot{N} (m⁻¹) | H |
| Column | 10 | 7927 | 1.40 |
| | 20 | 6514 | 1.71 |
| Cuboid z² | 10 | 8736 | 1.27 |
| | 20 | 6828 | 1.63 |

Error range: <±5% for experiments run in triplicate.

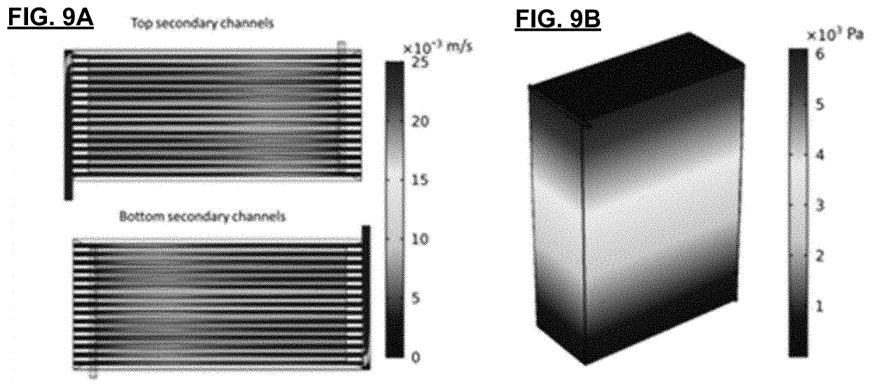

FIG. 9A shows the simulated velocity profiles in in the top and bottom secondary channels of a 200 mL cuboid z² device packed with Capto Q media, obtained by CFD, at a flow rate of 10 mL/min. As expected, the velocity in all the top secondary channels decreased from the inlet side to the outlet side, the inlet and outlet velocities in each of the channels being identical. The velocity in the bottom secondary channels increased from the inlet side to the outlet side in a complimentary manner with respect to that in the top channel. Once again, the inlet and outlet velocities in each of these channels were identical. FIG. 9B shows the simulated pressure profile within the same device at the same operating conditions, also obtained by CFD. The pressure decreased linearly from the top to the bottom, indicating that flow of liquid within the packed-bed took place uniformly in a downward direction without and side-wise deviations, i.e. the flow of liquid within the device could be classified at the three levels of hierarchy, as hypothesized earlier. This was sustained as the resistance to flow in the packed-bed was greater than that in the secondary channels, which in turn was greater than that in the primary channels.

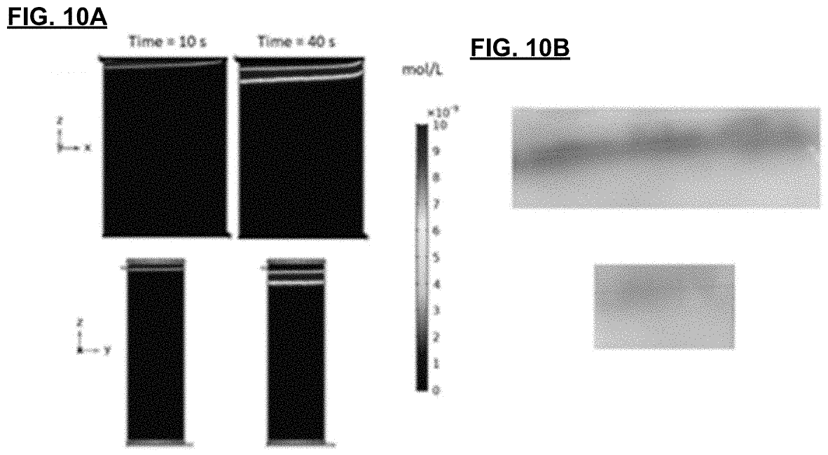

The shape of the solute front within a chromatography device during its transit was best observed using a dyed macromolecular tracer such as blue dextran. The solute front obtained using a large molecule is primarily influenced by macroscopic convective dispersion at the device inlet. The diffusion coefficient of such a macromolecules being low, any distortion or blurring of the solute front by diffusion is expected to be minimum. FIG. 10A shows the solute front obtained by CFD simulation for 2000 kDa dextran (1 mL pulse of 10 g/L solution) at 10 and 40 seconds within a 200 mL cuboid z² device containing Capto Q chromatographic media, at a flow rate of 10 mL/min. The two images on the top show the solute front in a section down the middle of the device, as viewed from the wider side. The two images on the bottom show the corresponding views from the narrower side of the device. As shown in FIG. 2A, the simulated solute front showed a pronounced backward slant and a very slight side-wise slant. FIG. 10B shows images of the actual solute front obtained by carrying out experiments using 2000 kDa blue dextran (1 mL pulse of 10 g/L solution, at a flow rate of 10 mL/min). The image on the top shows the solute front along the wider side of the device while the image on the bottom show the solute front along the narrower side of the device. Consistent with the hypothesis and CFD simulations, the experimentally obtained solute front had a significant backward and a slight side-wise slant. As reasoned earlier in the paper, such a combination of slants facilitates collimation of the solute front at the outlet of the cuboid z² device, resulting in a narrowing down of the residence time distribution, ultimately leading to a greater number of theoretical plates and a smaller plate height than other equivalent devices.

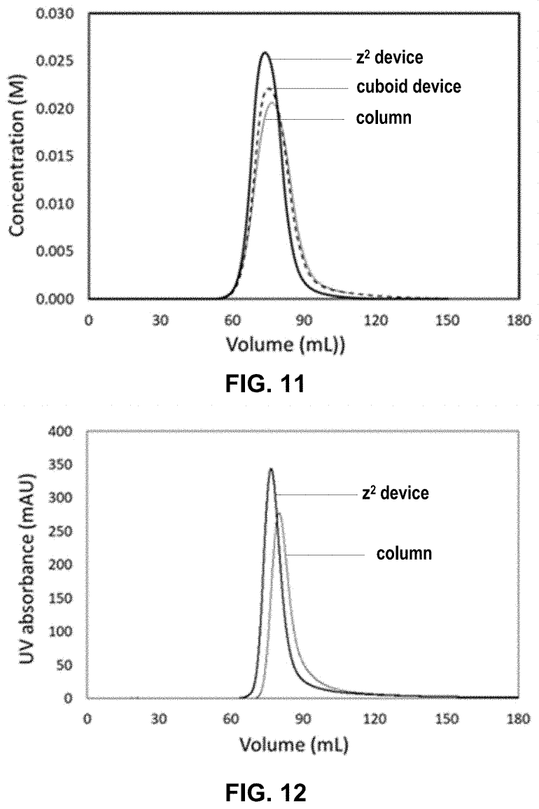

FIG. 11 shows the CFD simulated dextran tracer (1 mL pulse of 10 g/L solution) peaks for the 200 mL column, cuboid and cuboid z² devices packed with Capto Q strong anion exchange chromatographic media at 10 mL/min flow rate. Quite clearly, the peak obtained with the cuboid z² device was significantly sharper than that obtained with cuboid device. Both of these peaks were in turn substantially sharper than that obtained with the column. These results suggest the following hierarchy in the uniformity of flow: cuboid z² device>cuboid>column. Some of the macroscopic convective dispersion effect occurring within the column were corrected by using the cuboid device. By using the z² design feature, these effects were even further corrected.

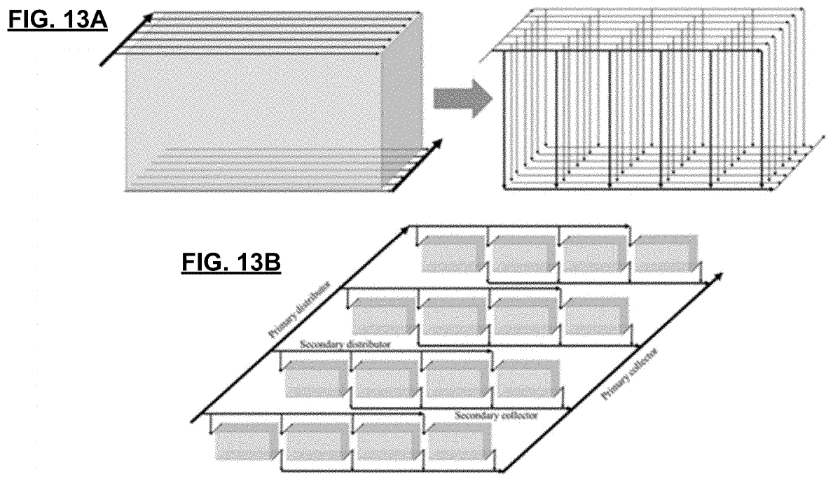

FIG. 12 shows the experimentally obtained 2000 kDa blue dextran tracer peaks for the 200 mL column and cuboid z² device packed with Capto Q strong anion exchange chromatographic media. Consistent with the results obtained by CFD simulation (see FIG. 10), the peak obtained with the cuboid z² device was substantially sharper than that obtained with the column. These experimental results confirmed that the uniformity of flow within the cuboid z² device was significantly greater than that in the equivalent column.

The above results clearly demonstrate that the efficiency of chromatographic separations could be enhanced using the novel z² flow distribution and collection feature. This feature also increases the scalability and compactness of a cuboid packed-bed device. The z² flow distribution and collection feature could also be incorporated in other types of chromatographic devices such as membrane adsorbers, and indeed in any situation where uniform flow in three-dimensional porous media is required. These results also show that the notion that the symmetric structure of a column and the axis-symmetric flow of fluids through it are somehow prerequisites for efficient chromatographic separation are not necessarily true. A potential advantage of using the z² flow distribution and collection feature is that it makes the device amenable to multiplexing by parallelization. FIG. 13A shows a schematic representation of fluid flow in an individual cuboid z² device that could be visualized as consisting of three levels of hierarchy. The primary level consisted of the fluid entering the device through the primary distributing channel at the top and leaving through the primary collection channel at the bottom. The secondary level consisted of the fluid flowing through the two sets of secondary distributing channels at the top and at the bottom of the packed-bed. The tertiary level consisted of the fluid flowing down vertically through the cuboid packed-bed. Using the same hierarchical flow structuring, several cuboid z² devices could be operated in parallel as shown in FIG. 13B. In this scheme, the primary flow takes place through the primary distribution and collection tubes which are analogous to the primary channels in an individual cuboid z² device. The secondary flow takes place through the secondary distribution and collection tubes which are analogous to the secondary flow channels present in an individual cuboid z² device. The tertiary flow takes place through each of the cuboid z² devices that have been parallelized as shown in FIG. 13B. Such manner of multiplexing could be described as fractal scaling as the same scaling rule is applied consistently to an individual device and a parallelized network consisting of several devices.

### II. 1-15 mL Membrane Device

In order to assess the impact of adding the z² flow distribution and collection feature in the LFMC device, theoretical plate measurement experiments were carried out using sodium chloride as tracer solute. In these experiments, which were carried out at different flow rates, 0.4 sodium chloride solution was used as mobile phase while 0.8 M sodium chloride solution was used as the tracer solution. The volume of tracer solution injected to obtain the salt peaks was 1% of respective membrane bed volume. The salt peak was monitored based on the conductivity measurement of the effluent stream. The peak retention volume (V_{R}) and the peak width at half height (w_{0.5}) was then used to calculate the number of theoretical plates using the Equation (3) shown below:

$$N = 5.545 {( \frac{{V}_{R}}{{w}_{0.5}} )}^{2} \qquad ( 3 )$$

Table 5 shows the number of theoretical plates per meter of membrane bed-height (N/m) for the 5 mL Q z²LFMC device. The best performance was obtained at 10 mL/min flow rate (˜42,000 plates/m) with the number hovering above 40,000 plates/m in the 10 to 17.5 mL/min flow rate range. These numbers were significantly greater (almost double) than that reported in the literature (i.e. ˜21000 plates/m) for the particular type of membrane used in this device, i.e. Mustang Q. Therefore, the z² flow distribution and collection feature did indeed serve its intended purpose. The number of theoretical plates per meter obtained with the 5 mL Q z²LFMC device decreased at flow rates lower and higher than the optimum flow rate. This is consistent with the van Deemter equation, Equation (4) provided below, which predicts the existence of a superficial velocity (flow rate divided by the area of cross-section) at which the performance is optimum, with lower efficiencies both below and above it:

H=A+(B/u)+Cu (4)

where H is the height equivalent of a theoretical plate (inverse of N/m), u is the superficial velocity, A is the eddy dispersion term, B is the axial dispersion term, and C is the solute transfer term.

TABLE 5
Effect of flow rate on the number of theoretical plates per meter
membrane bed-height for the 5 mL Q z²LFMC device (average data
based on experiments run in triplicate, rounded up to whole number).

| Flow rate | Superficial | Theoretical plates per | Plate height |
|---|---|---|---|
| (mL/min) | velocity (cm/h) | meter bed height (/m) | (cm) |
| 5 | 21.4 | 33249 | 0.00300 |
| 7.5 | 32.1 | 36815 | 0.00272 |
| 10 | 42.9 | 42235 | 0.00237 |
| 12.5 | 53.6 | 41663 | 0.00240 |
| 15 | 64.3 | 41054 | 0.00244 |
| 17.5 | 75.0 | 40272 | 0.00248 |
| 20.0 | 85.7 | 36499 | 0.00274 |
| 22.5 | 96.4 | 32004 | 0.00313 |

Table 6 shows the number of theoretical plates per meter of membrane bed-height at different flow rates for the 15 mL S z²LFMC device. The data indicated that with this device, the separation efficiency remained largely unchanged in the flow rate range examined. The number of theoretical plates per meter obtained with the 15 mL S z²LFMC device (i.e., 30,000 to 31,000 plates/m) were higher than those reported in the literature (in the 14,000 to 25,000 plates/m range) for the older version of the LFMC device, for the same membrane, i.e., Sartobind S. The higher plates/m values obtained with the 5 mL Q z²LFMC device in comparison to the 15 mL S z²LFMC device could be explained in terms of the differences in the physical properties of the membranes used in these devices. The pore size of the Mustang Q membrane used in the 5 mL Q z²LFMC device was 0.8 micron. This was much smaller than the pore size of the Sartobind S membrane used in the 15 mL S z²LFMC device (3-5 microns). Also, such difference in fluidic attributes of the two membranes could be the reason why the plate number in the one of them is less sensitive to the flow rate than the other. As discussed in our paper on the cuboid packed-bed device with the z² flow feature, the residence time along each hypothetical flow path within the device is identical. This reduces the dispersion effects within the device and contributes toward enhancement and separation efficiency. Also, the fact that the residence time is independent of the flow path implies that the device would be more scalable. The large area of cross-section of an MC device allows it to be operated at very high flow rate (and thereby very high number of bed volumes per unit time) at a relatively low superficial velocity. Therefore, very high resolution can potentially be obtained without sacrificing the productivity.

TABLE 6
Effect of flow rate on the number of theoretical plates per meter
membrane bed-height for the 15 mL S z²LFMC device (average data
based on experiments run in triplicate, rounded up to whole number).

| Flow rate | Superficial | Theoretical plates per | Plate height |
|---|---|---|---|
| (mL/min) | velocity (cm/h) | meter bed height (/m) | (cm) |
| 10 | 42.9 | 30707 | 0.00326 |
| 12.5 | 53.6 | 31376 | 0.00319 |
| 15 | 64.3 | 30882 | 0.00324 |
| 17.5 | 75.0 | 30974 | 0.00323 |
| 20 | 85.7 | 30245 | 0.00331 |

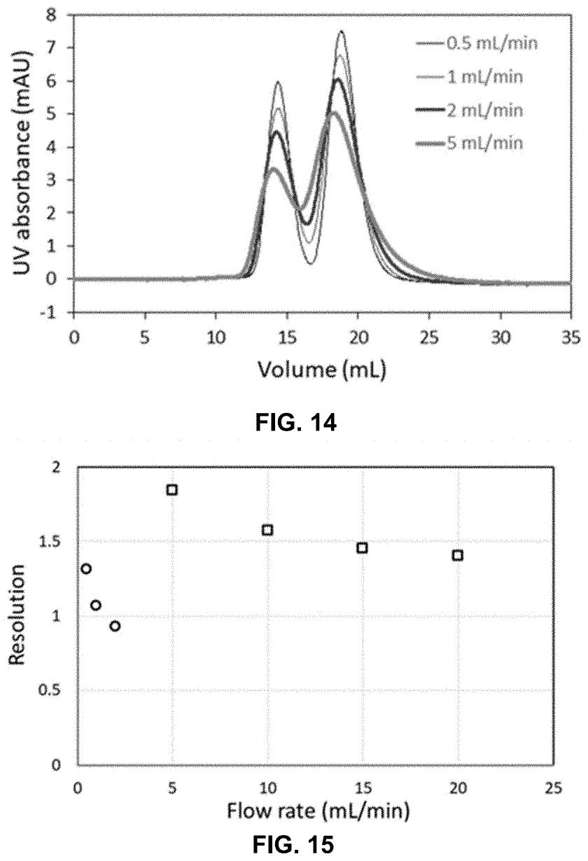

In order to verify whether the high number of theoretical plate/m obtained with the z²LFMC devices had any actual impact on the resolution in a protein purification process, head-to-head binary protein separation experiments were carried out with a 5 mL strong anion exchange Q z²LFMC device and a 5 mL HiTrap QFF strong anion exchange column using BSA and transferrin as model proteins. QFF resin was selected as a benchmark for comparison as it is widely used in the biopharmaceutical industry for high-resolution anion-exchange separations. The 5 mL HiTrap QFF column which had a bed-height of 25 mm and a diameter of 16 mm was found to have about 4,400 theoretical plates/m at a superficial velocity of 30 cm/h. FIG. 14 shows the chromatograms for transferrin/BSA separation obtained with the 5 mL HiTrap QFF column at four different flow rates (i.e., 0.5, 1, 2 and 5 mL/min), using 15 mL linear gradient. The resolution R, as defined in Equation (5) below obtained in these experiments are summarized in FIG. 15. In Equation (5), V_{R} is the retention volume, w_{0.5} is the peak width at half height, while superscripts b and a stand for BSA (the second peak) and transferrin respectively. At 5 mL/min flow rate, the peaks were not resolved below their respective half-heights and R could not be calculated. Close to baseline resolution was obtained at the lowest flow rate examined, i.e., 0.5 mL/min (u=15 cm/h).

$$R = 1.18 \times \frac{{V}_{R}^{b} - {V}_{R}^{a}}{{w}_{0.5}^{a} + {w}_{0.5}^{b}} \qquad ( 5 )$$

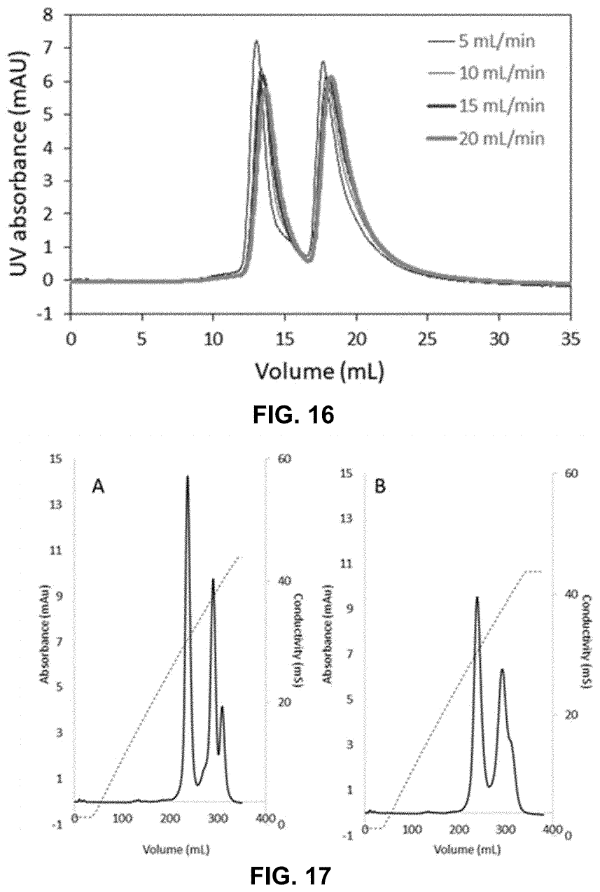

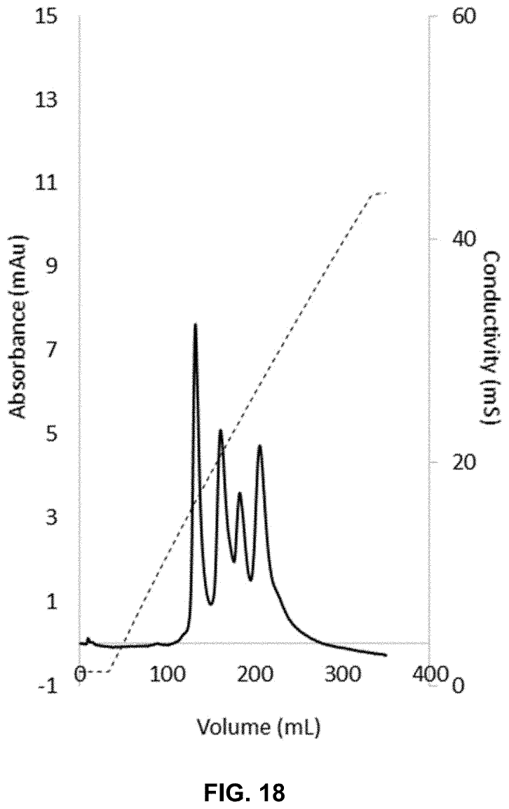

FIG. 16 shows the chromatograms of transferrin/BSA separation obtained with the 5 mL Q z²LFMC device at four different flow rate (i.e., 5, 10, 15 and 20 mL/min). Very high resolution was obtained at all four flow rates examined (see FIG. 15 for resolution data). The resolution obtained at the highest flow rate examined with the 5 mL Q z²LFMC device (i.e., 20 mL/min; u=85.7 cm/h) was similar to that obtained at the lowest flow rate examined with the 5 mL HiTrap QFF column (i.e., 0.5 mL/min; u=15 cm/h). Therefore, comparable resolution to that obtained with the 5 mL QFF resin based column could be obtained with the Q z²LFMC device at 40-time higher flow rate, i.e. similar product quality at 40-time productivity. With the 5 mL HiTrap QFF column, the resolution decreased very significantly as the flow rate was increased. However, with the 5 mL Q z²LFMC device, the resolution remained consistently high over the entire flow rate range examined. These results demonstrate that the z²LFMC based process combines ultra-high-speed with high-resolution, a win-win situation for a separation process.

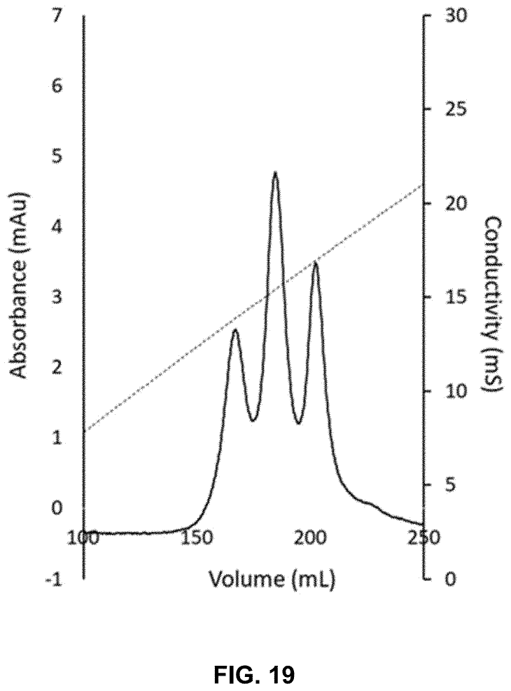

Head-to-head model protein separation experiments were also carried out using the 15 mL strong cation exchange S z²LFMC device and a 15 mL column packed with Capto S ImpAct resin. The column had a diameter of 16 mm and was packed to 15 mL bed volume (i.e. 75 mm bed height) using the manufacturers protocol. The Capto S ImpAct resin has been developed for high-resolution biopharmaceutical purification and is widely used for carrying out challenging separations. The theoretical plate number for the 15 mL Capto S ImpAct column was found to be about 4,800 plates/m at a superficial velocity of 30 cm/h. The model proteins used in these experiments were conalbumin (pI=6.6, MW=43.5 kDa), ribonuclease A (pI=8.65, MW=13.7 kDa), cytochrome C (pI=9.6, MW=11.7 kDa), and lysozyme (pI=10.7, MW=14.4 kDa). Based on their respective isoelectric points, these proteins are expected to be eluted in the above order in cation exchange chromatography. The respective concentrations of the four proteins in the feed solution were 1.5 mg/mL, 1.0 mg/mL, 0.5 mg/mL, and 0.5 mg/mL. These concentrations were chosen to obtain approximately equal sized peaks in a resolved chromatogram. In these model protein separation experiments, 20 mM sodium acetate buffer (pH 5.0) was used as binding buffer while 20 mM sodium acetate buffer (pH 5.0)+0.5 M sodium chloride was used as eluting buffer. FIGS. 19A and 19B show the chromatograms obtained with the 15 mL Capto S ImpAct column at two different flow rates, i.e. 2 mL/min (u=60 cm/h) and 10 mL/min (u=300 cm/h) respectively, using the same linear gradient for elution, i.e. 300 mL. At these flow rates, the four model proteins could not be satisfactorily separated. At 10 mL/min flow rates, conalbumin and ribonuclease A appeared as a composite peak in the chromatogram around 240 mL effluent volume, while cytochrome C and lysozyme appeared as a composite peak around 290 mL effluent volume. At 2 mL/min flow rate, lysozyme could be resolved from cytochrome C but conalbumin and ribonuclease A still appeared as a single composite peak.

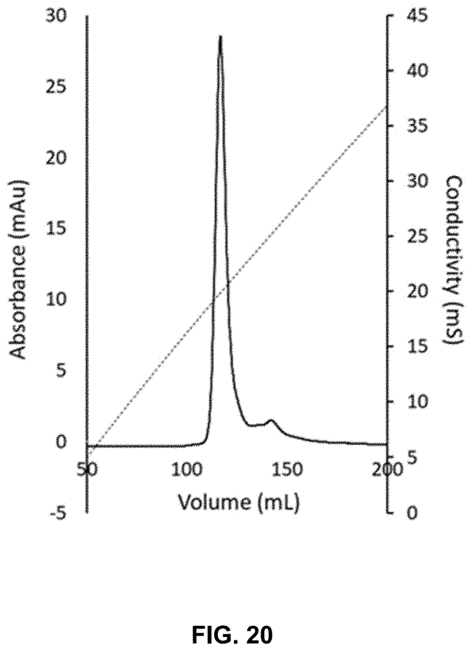

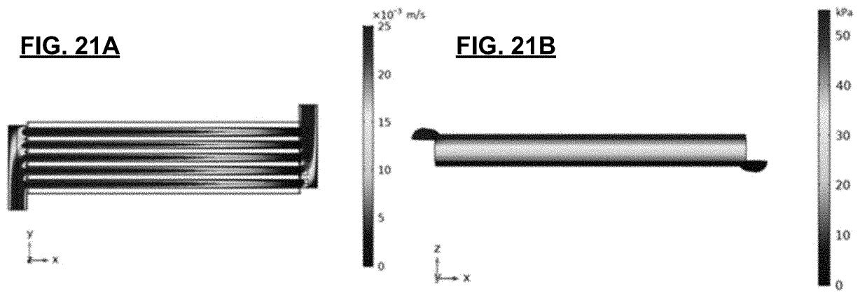

FIG. 20 shows the chromatograms obtained with the 15 mL S z²LFMC device at a flow rate of 15 mL/min (u=64.3 cm/h), using the same linear gradient for elution as used with the 15 mL Capto S ImpAct column, i.e. 300 mL. Quite clearly, the four model proteins were resolved as separate peaks using the 15 mL S z²LFMC device. These results demonstrate that the resolution obtained with the 15 mL S z²LFMC device was greatly superior than that obtained with a similar sized packed column, even at significantly higher flow rates than those used with the column. It is conceivable that at very low flow rates, the resolution obtained with the column would be similar to that obtained with the z²LFMC device (as in the case of the results shown in FIG. 17). However, this implies that for the same purity, the productivity would be substantially greater with the 15 mL S z²LFMC device. The pressure drop across the 15 mL Capto S ImpAct column at a flow rate of 10 mL/min was about 0.16 MPa, which was similar to that to that across the 15 mL S z²LFMC device at a flow rate of 15 mL/min.

Having clearly demonstrated the superior separation attributes of the z²LFMC devices, vis-a-vis their equivalent resin-based columns, the suitability of these devices was assessed for carrying out high-resolution, biopharmaceutical purifications. Monoclonal antibody charge variants which differ only slightly in terms of their isoelectric points are formed during manufacture and storage due to chemical modifications such as deamidation, oxidation and isomerization. Charge variants may have quite different therapeutic and pharmacokinetic properties and hence their presence in a mAb formulation is undesirable. Efficient methods for preparative separation of these charge variants would therefore be quite desirable. A monoclonal antibody sample (hIgG1-CD4), known to contain three charge variants were fractionated using the 15 mL S z²LFMC device. The hIgG1-CD4 sample examined in this study contained an acidic and a basic variant in addition to the main mAb population (neutral). In a previous study, the inventors demonstrated that LFMC could be used for efficient high-resolution fractionation of hIgG1-CD4 charge variants. Here, the efficiency of charge variants separation could be further improved by using an z²LFMC device. In these experiments, 20 mM sodium acetate buffer (pH 5.0) was used as binding buffer while 20 mM sodium acetate buffer (pH 5.0)+0.5 M sodium chloride was used as eluting buffer. The monoclonal antibody feed solution was prepared by diluting a stock solution in binding buffer. FIG. 19 shows the chromatogram obtained when the mAb charge variants separation was carried out using the 15 mL S z²LFMC device at a flow rate of 20 mL/min using 500 mL linear gradient. The volume of hIgG1-CD4 solution (0.479 mg/mL) injected in these experiments was 1 mL. The acidic, neutral and basic mAb variants were efficiently resolved and obtained as peaks around 165 mL, 185 mL, and 202 mL effluent volume respectively. The resolution in hIgG1-CD4 charge variant fractionation obtained with the z²LFMC device was better than that obtained with the LFMC device housing a similar membrane stack. These results prove that the z²LFMC device could be used for carrying out high-resolution separation of multiple proteins having very subtle difference in isoelectric point, the separation being comparable to that obtained with resin-based columns.

Separation of monoclonal antibody aggregates is a major challenge in the field of bioseparations engineering. Antibodies aggregate due to a variety of physical and chemical interactions and the presence of aggregates in monoclonal antibody formulations is undesirable. The feasibility of separating Campath 1H aggregates from its monomeric form was examined using a 15 mL S z²LFMC device. FIG. 20 shows a chromatogram obtained by loading 5 mL of aggregate containing mAb sample. The mAb concertation in these samples was 0.3 mg/mL and these were prepared by diluting a mAb stock solution in binding buffer. The separation was carried out at 20 mL/min flow rate using a linear gradient length of 200 mL. The monomer-aggregate resolution obtained at both sample loadings were qualitatively comparable. The mAb monomer and aggregates were obtained at 117 mL and 143 mL effluent volumes respectively. These results clearly shown that the z²LFMC device could be used for carrying out a challenging separations such as the removal of undesirable aggregated proteins from biopharmaceutical products and thereby increase their safety and efficacy

FIG. 21A shows the CFD simulated velocity profiles in the top primary channel and in the set of top secondary channels in a 1 mL z²LFMC module. These simulations were carried out using water as the flowing liquid, at a module inlet flow rate of 5 mL/min, i.e. 5 membrane bed-volumes per minute. The velocity profile in the bottom primary channel can also be seen on the right hand side of the figure. The average velocity of flow decreased along the length of the top primary channel due to the sequential branching off of liquid to the top secondary channels. The velocity in a top secondary channel decreased linearly from left to right due to ingress of liquid in the membrane stack below it. The velocity profiles in all the top secondary channels were identical. This happened as the hydraulic resistance in the primary channel was lower than in a secondary channel, while that in a secondary channel was in turn lower than in the portion of the membrane stack below it. The flow velocity in the set of bottom secondary channels (data not shown) increased from left to right due to collection of liquid from the membrane stack above. Also, the velocity profiles in each of these channels were identical (data not shown). The velocity in the bottom primary channel increased towards the outlet due to sequential collection of liquid from the bottom secondary channels. FIG. 21B shows the CFD simulated pressure profile within the membrane stack along the x-z plane. The pressure decreased uniformly along the z-axis, while there was no change along the x- or y-axes. This indicated that the flow within the membrane stack took place only along the z-axis, i.e. in the normal direction. FIG. 21B also shows the pressure within the top and bottom secondary channels. The change in the pressure in both sets of secondary channels was extremely small (virtually imperceptible based on the colour-coded pressure scale), when compared to that in the membrane stack.

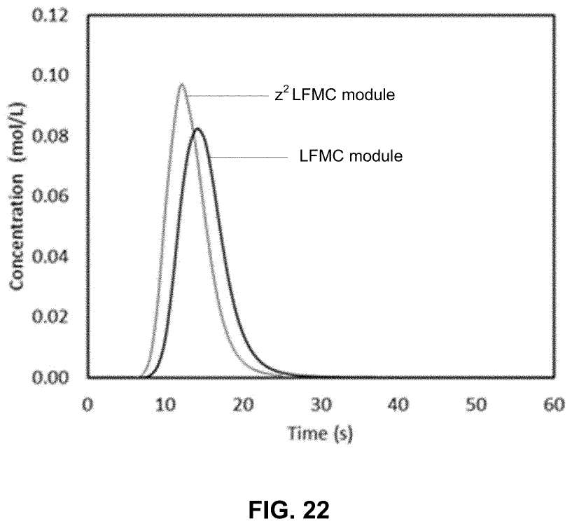

The transit of a non-interacting tracer solute pulse through a chromatography device reveals vital information about the nature of fluid flow through it. CDF simulations were carried out using water as mobile phase, and 2 M sodium chloride solution (pulse volume=25 μL) as the tracer solution, at a flow rate of 5 mL/min. FIG. 22 shows the sodium chloride concentration profiles at the module outlet, i.e. the respective flow-through salt peaks, obtained using the 1 mL LFMC module with tapered flow distribution (thick line) and the 1 mL z² LFMC module (thin line). The flow-through peak obtained with the latter was narrower and sharper. This indicated that in a given chromatographic process using these two modules, better separation efficiency could be expected with the z²LFMC module. The above simulations clearly show that the z² flow distribution feature made a significant difference even in a small (1 mL) module. Therefore, it could be inferred that this feature would be even more beneficial in larger modules.

As discussed above, one potential application of the z² LFMC devices described herein is chromatographic separation and purification of chemical substances including, pharmaceuticals and biopharmaceuticals. The devices described herein provide for the flow path lengths within the devices to be the same, minimize back mixing and ensure flow uniformity within the device. By doing so, the devices described herein minimize solute residence time distribution (RTD) within the device. In a chromatographic separation process, a lower RTD results in improvement in efficiency of separations, i.e. higher resolution, product recovery and purity. In addition to enhancement in separation attributes, the use of this feature also increased the compactness and scalability of the device. The independence of residence time with respect to the flow path implies that the device would be more scalable. Also, such a device is potentially amenable to scale-out by parallelization. The hierarchical flow distribution and collection arrangements used in e devices described herein could be more widely applicable for ensuring flow uniformity in 3-dimensional porous media in general. For instance, this flow enhancement feature could also be used to improve the efficiency of monolith based chromatographic separations or to use catalytic membrane or catalytic particle based fixed-bed reactors more efficiently.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A chromatography device for removing a solute from a fluid, the device comprising:
a first plate having an inlet, a first primary channel fluidly coupled to the inlet and a first set of secondary channels, each secondary channel of the first set of secondary channels being fluidly coupled to the first primary channel;
a middle frame housing chromatographic media, the chromatographic media being configured to remove the solute from the fluid as the fluid passes through the chromatographic media; and
a second plate having an outlet, a second primary channel fluidly coupled to the outlet and a first set of secondary channels, each secondary channel of the second set of secondary channels being fluidly coupled to the second primary channel;
wherein the first set of secondary channels directs the fluid over a top surface of the chromatographic media in a first direction that is transverse to a direction of flow of the fluid through the chromatographic media; and
the second set of secondary channels collects the fluid from a bottom surface of the chromatographic media after the fluid has passed through the chromatographic media and directs the fluid to the outlet in a second direction that is transverse to the direction of flow of the fluid through the chromatographic media.

2. The chromatography device of claim 1, wherein the first set of secondary channels and the second set of secondary channels each include two or more secondary channels spaced apart from each other.

3. The chromatography device of claim 2, wherein each secondary channel of the first set of secondary channels is positioned to be opposed from a secondary channel of the second set of secondary channels.

4. The chromatography device of claim 1, wherein each channel of the first set of secondary channels is configured to have a greater resistance to flow of the fluid than the first primary channel and each channel of the second set of secondary channels is configured to have a greater resistance to flow of the fluid than the second primary channel.

5. The chromatography device of claim 1, wherein each channel of the first set of secondary channels is configured to have a smaller resistance to flow of the fluid than the chromatographic media and each channel of the second set of secondary channels is configured to have a smaller resistance to flow of the fluid than the chromatographic media.

6. The chromatography device of claim 1, wherein each of the first primary channel and the second primary channel are configured to have a smaller resistance to flow of the fluid than the chromatographic media.

7. The chromatography device of claim 1, wherein each secondary channel of the first set of secondary channels has a first same diameter and each secondary channel of the second set of secondary channels has a second same diameter.

8. The chromatography device of claim 7, wherein the first same diameter and the second same diameter are the same.

9. The chromatography device of claim 1, wherein the first direction is normal to the direction of flow of the fluid through the chromatographic media.

10. The chromatography device of claim 1, wherein the first direction is normal to a direction of flow of the fluid through the first primary channel.

11. The chromatography device of claim 1, wherein the second direction is normal to the direction of flow of the fluid through the chromatographic media.

12. The chromatography device of claim 1, wherein the second direction is normal to a direction of flow of the fluid through the second primary channel.

13. The chromatography device of claim 1, wherein the first primary channel carries the fluid in a direction that is parallel to a direction of flow of the fluid through the second primary channel.

14. The chromatography device of claim 1, wherein the first direction and the second direction are parallel.

15. The chromatography device of claim 1, wherein the chromatographic media is a packed bed, a membrane sheet or a stack of membrane sheets.

16. The chromatography device of claim 1, wherein each channel of the first set of secondary channels is equally spaced apart from at least one other channel of the first set of secondary channels along a width of a top surface of the chromatographic media and each channel of the second set of secondary channels is equally spaced apart from at least one other channel of the second set of secondary channels along a width of a bottom surface of the chromatographic media.

17. The chromatography device of claim 1, wherein the first primary channel is laterally offset from at least a portion of the chromatographic media.

18. The chromatography device of claim 1, wherein each of the channels of the first set of secondary channels is engraved in the first plate and each of the channels of the second set of secondary channels is engraved in the second plate.

19. The chromatography device of claim 1, wherein each of the channels of the first set of secondary channels is embedded in the first plate and includes one or more access holes to provide for the fluid to pass from the each of the channels of the first set of secondary channels to the chromatographic media, and each of the channels of the second set of secondary channels is embedded in the second plate and includes one or more access holes to provide for the fluid to pass from chromatographic media to the each of the channels of the second set of secondary channels.

20. A system for removing a solute from a fluid including two or more of the chromatography devices of claim 1 fluidly coupled to each other in parallel.
